(19) United States
(12) Patent Application Publication
(10) Pub. No.: US 2014/0319241 A1
(43) Pub. Date: Oct. 30, 2014

(54) SYSTEM AND METHOD FOR HUMIDIFYING A SYSTEM FOR APPLYING A COATING TO A WORKPIECE

(71) Applicant: ARMSTRONG WORLD INDUSTRIES, INC., Lancaster, PA (US)

(72) Inventors: Sebastien NALIN, Lancaster, PA (US); Scott L. HUNTZINGER, Lancaster, PA (US)

(73) Assignee: Armstrong World Industries, Inc., Lancaster, PA (US)

(21) Appl. No.: 13/873,822

(22) Filed: Apr. 30, 2013

(51) Int. Cl. B05C 9/12

(52) U.S. Cl. CPC B05C 9/12
USPC 239/104

(57) ABSTRACT

A system for applying a coating to a workpiece includes an applicator head and a humidifying apparatus. The applicator head is configured to direct water-based liquid onto the workpiece and remove excess liquid through a vacuum. The humidifying apparatus is operably coupled to a steam source and includes first and second steam exhausts configured to direct steam toward the applicator head. The first steam exhaust is located at a first angular position relative to an axis of the applicator head, and the second steam exhaust is located at a second angular position relative to the axis of the applicator head, with the first angular position being different than the second angular position.

### FIELD OF THE INVENTION

The field of the present invention relates to systems and methods for applying a coating to a workpiece with a sprayed liquid, and particularly to systems and methods for reducing maintenance requirements due to the sprayed liquid drying on parts of the coating system.

### BACKGROUND OF THE INVENTION

Edge-coating a workpiece as it moves along in a direction generally parallel to its edge is generally known. Systems have been developed that spray the passing edge with a liquid and then vacuum the excess liquid, off the edge in order to obtain a very smooth and uniform coating of the liquid on edge of the workpiece.

U.S. Pat. No. 5,298,072 describes a system for coating the edges of panels (and other types and forms of workpieces) in which the panel is moved along a conveyor past a painting station, so that the edge of the panel moves longitudinally past the applicator head, which serves as both a spray head to apply the paint and a vacuum head to remove excess paint. The applicator head is shaped to have a complementary shape to the shape of the edge of the panel, and as the panel moves past the applicator head, paint is applied and excess paint is removed to leave the smooth finish.

Problems with this prior art system are found in the premature drying of the applied liquid, either on the workpiece or on parts of the system itself. Such premature drying of the applied liquid requires increased maintenance of the system to ensure that paint feed lines the applicator had and vacuum removal lines are not clogged by the dried liquid residuals.

### SUMMARY OF THE INVENTION

The present invention is directed toward a humidifying apparatus for use with a system for applying a coating to a workpiece and a method for coating a workpiece. The humidifying apparatus is disposed near the applicator head, which is configured to coat the workpiece using a liquid and remove the excess liquid, and it is configured to moisten the environment in and around the applicator head.

According to an embodiment, a humidifying apparatus is operably coupled to a steam source, and the humidifying apparatus includes first and second steam exhausts, with each steam exhaust being configured to direct steam toward an applicator head. The first steam exhaust is located at a first angular position relative to an axis of the applicator head, and the second steam exhaust is located at a second angular position.

According to another embodiment, a humidifying apparatus is operably coupled to a steam source, and the humidifying apparatus includes a steam supply manifold affixed to an applicator head. The steam supply manifold further includes a plurality of steam ports configured to direct steam toward at least two peripheral sides the applicator head.

According to another embodiment, at least one steam supply conduit is operably coupled to a steam port, and first and second steam exhausts are operably coupled to the at least one steam supply conduit. The first and second steam exhausts are configured to direct steam toward at least two different peripheral sides of a reference zone.

According, to another embodiment, at least two steam exhausts are positioned to direct steam toward at least two peripheral sides of an applicator head. The at least two steam exhausts are coupled to a steam source through at least one steam supply conduit, and the steam source is activated to dispense steam through the at least two steam exhausts upon activation of the applicator head.

### BRIEF DESCRIPTION OF THE DRAWINGS

The foregoing summary, as well as the following, detailed description of the exemplary embodiments, will be better understood when read in conjunction with the appended drawings. It should be understood, however, that the invention is not limited to the precise arrangements and instrumentalities shown in the following figures:

FIG. 1 is a perspective view of an edge coating apparatus;

FIG. 2 is a sectional view of a spray head and associated steam ports;

FIG. 3 is a front plan view of a spray head and first steam manifold;

FIG. 4 is a front plan view of a spray head and second steam manifold; and

FIGS. 5A-G are schematic illustrations of spray heads and the positions of associated steam ports.

### DETAILED DESCRIPTION OF EXEMPLARY EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in an way to limit the scope of the present invention. Relative terms such as “lower,” “upper,” “horizontal,” “vertical,” “above,” “below,” “up,” “down,” “left,” “right,” “top” and “bottom” as well as derivatives thereof (e.g. “horizontally,” “downwardly,” “upwardly ,” etc.) should he construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combinations of features that may exist alone or in other combinations of features; the scope of the invention being defined by the claims appended hereto.

In the context of the description below, the liquid is discussed in terms of a water-based paint. However, as is known to those of skill in the art, the liquid can also be a primer, a lacquer, a preservative, or any other desired treatment liquid that is appropriate as a coating for a particular workpiece and the intended utilization of that workpiece. In addition, the liquid may serve as a carrier for solid or filler particles. For example, the filler particles may have an average particle size ranging, from about 100 microns to 600 microns, and the liquid carrier may have a composition of up to 90% of filler particles by dry solids weight. Examples of filler particles includes calcium carbonate, dolomite, dolomitic limestone or combinations thereof. In addition to the solid or filler particles, the liquid ma also include as part of its composition a binder and/or a pigment, as desired by design choice for a particular coating application. Examples of binders that may be included in the liquid include natural polymers, modified natural polymers, synthetic polymers and combinations thereof. The synthetic polymers are formed from the following monomers: vinyl acetate, vinyl propionate, vinyl butyrate, ethylene, vinyl chloride, chloride, vinyl fluoride, vinylidine fluoride, ethyl acrylate, methyl acrylate, propyl acrylate, butyl acrylate, ethyl methacrylate, methyl methacrylate, butyl methacrylate, hydroxyethyl methacrylate, styrene, butadiene, urethane, epoxy, melamine, ester, and combinations thereof. U.S. Pat. No. 7,033,963, the disclosure of which is incorporated herein by reference in its entirety, describes other examples of liquids that may be used with the coating system described below. The coating system may also be used with other types of liquids (and liquid compositions), other than those referenced herein.

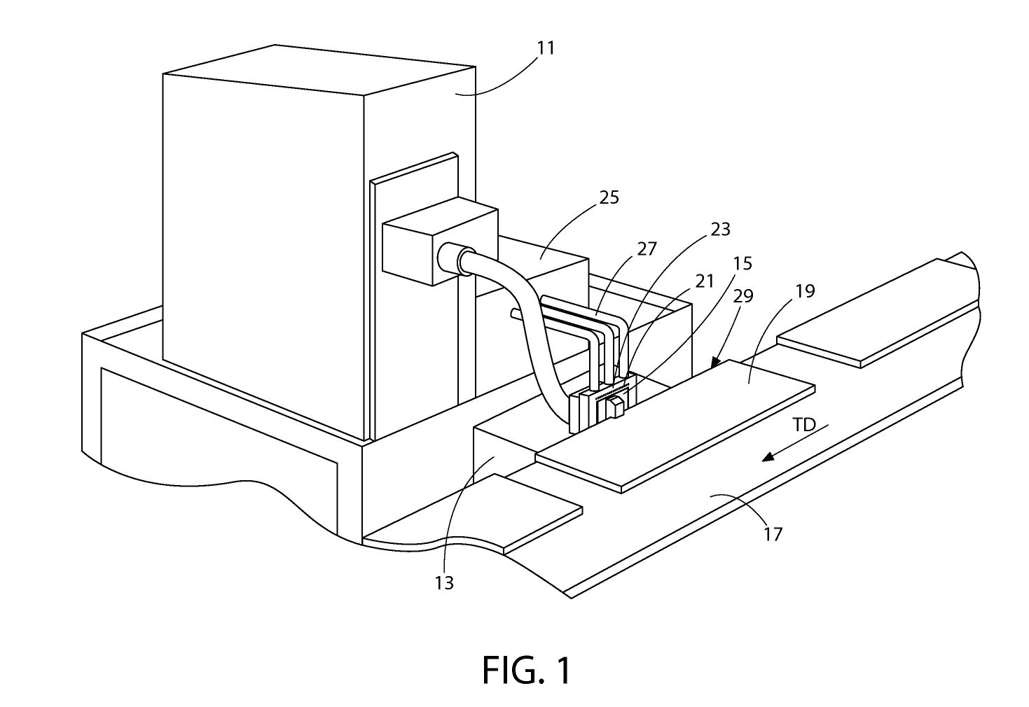

As seen in FIG. 1, a vacuum tank 11 and a paint feed apparatus 13 are both coupled to an edge-coating applicator head 15. The applicator head 15 is arranged adjacent a conveyor 17 which transports workpieces 19 past the applicator head 15, in a transport direction, TD, so that the edges 29 of the workpieces 19 can be coated. Details of such an edge coater may be found in U.S. Pat. No. 5,298,072, the disclosure of which is incorporated herein by reference in its entirety.

Steam exhausts 21 are formed in conduits 23 affixed to the applicator head 15. The steam exhausts 21 are coupled to a steam source 25 by steam supply conduits 27. As is described in further detail below, these steam exhausts 21 help maintain a moist environment in and around the applicator head 15 in order to avoid a build-up of dried paint during operation. The steam source 25 is of the type known to those of skill in the art, which enables steam to be produced at a desired volume and exhausted through the steam supply conduits 27 at a desired pressure. Such a steam source 25 enables the amount of moisture introduced by the steam exhausts 21 at the applicator head 15 to be fully adjustable to account for the type of liquid, being used and the rate of application to the workpieces. It should be noted that the term “steam,” as used herein, includes without limitation: water in its vapor form; a mixture of a gaseous carrier and water in its vapor form; and a combination of a gaseous carrier and water in droplet liquid form.

The introduction of moisture into the environment in and around the applicator head 15 brings one or more potential benefits to the application system. One benefit that may arise through the introduction of moisture is that it allows the use of liquid carriers with high solid content, such as high solids paints. Another benefit may arise due to the fact that vacuum coating using the system described in U.S. Pat. No. 5,298,072 tends to accelerate drying of the paint, so that the excess paint that is vacuumed into the equipment begins to accumulate on both external and internal parts of the equipment. The addition of a humidifying system to a vacuum coating system aids in maintaining a continuous moist environment, both inside and outside the applicator head, so that the build-up of dried paint can be significantly reduced, if not entirely eliminated for some configurations. Also, because of the moisture being introduced, another benefit may arise by helping to maintain properties of the liquid, such as viscosity and/or solids content, thus helping to maintain a stable quality of the liquid for coating. Yet another benefit that may arise is reduced maintenance requirements (e.g., frequency of maintenance and/or reduced time to conduct maintenance) for the system due to a decrease in dried residue from the liquid adhering both externally and internally one the applicator head.

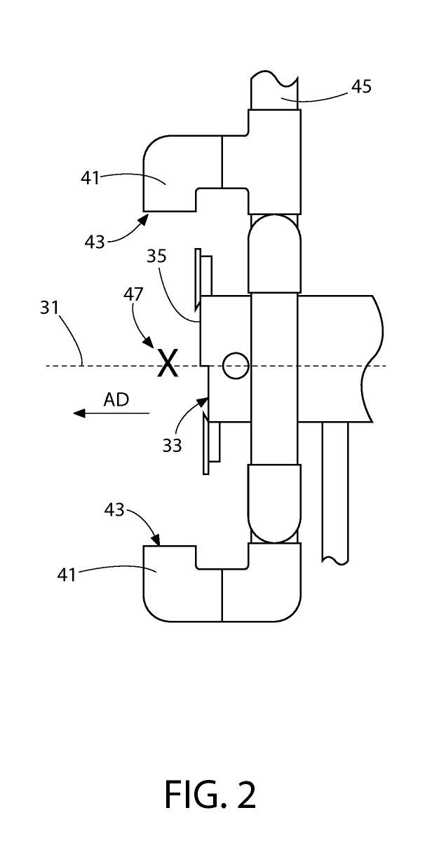

FIG. 2 illustrates a side detailed view of the applicator head 15 with conduits 27 for steam exhausts 21 affixed thereto, and an edge 29 of a workpiece 19 interfacing with the applicator head 15 to be coated. The applicator head 15 has an axis 31 associated with it, the axis 31 being substantially perpendicular to the travel direction, TD, of the workpiece and substantially parallel to an application direction, AD, of the applicator head. As described in U.S. Pat. No. 5,298,072, such vacuum coating applicator heads typically include a chamber formed with an opening 33 facing the passing workpieces 19, with the edge 35 of the opening 33 having a shape that is complementary to the shape of the workpiece edges 29 being coated. During operation, as the workpiece edge 29 passes by the opening 33, there is a small amount of play forming a gap between the workpiece edge 29 and the edge 35 of the opening 33. The interior chamber of the applicator head 15 is maintained at a vacuum by the vacuum tank, and the liquid being sprayed is introduced into the interior chamber by the feed inlet 39. Inside the applicator head, the liquid is atomized by turbulences created by the vacuum within the interior chamber, creating a fine mist that coats the workpiece edge 29 thoroughly. The turbulence also serves to draw off excess liquid while ensuring uniform coating of the edge surface. In other embodiments, the applicator head may be of any type, including a common spray nozzle, and the like. Certain embodiments may also include multiple applicator heads, and depending upon the proximity of the multiple applicator heads, one or more steam exhausts may be associated with the applicator heads.

Two steam exhausts 41 are shown in FIG. 2, positioned on opposite peripheral sides of the applicator head 15, and each steam exhaust 41 in this embodiment includes a single steam port 43. The steam exhausts 41 are coupled to a single steam supply conduit 45, which is in turn coupled to the steam generator. The steam exhausts 41 are positioned to direct steam toward the axis 31, and in certain embodiments toward a reference zone 47 (marked by an ‘X’), which is a zone disposed between the steam exhausts, residing at approximately the edge 35 of the opening 33, when the steam exhausts are affixed on or about the applicator head. As should be apparent from the ensuing description, embodiments may include more the two steam exhausts, embodiments may include steam exhausts with a plurality of steam ports, embodiments may include steam exhausts which are incorporated as part of a steam manifold disposed about the applicator head 15, and embodiments may include steam ports having an geometrical configuration, from a circular hole, to slots, to irregular shapes. In certain embodiments, the steam generator provides a high volume of steam to help ensure that steam emerging from the steam exhausts 41 fully surrounds the applicator head 15. A high volume of steam may be desirable, in certain embodiments, based on the type of liquid being used for the coating. In addition, the pressure of steam emerging from the steam exhausts 41 may be determined based on the rate of production the steam source and the size and number of steam ports included in each steam exhaust.

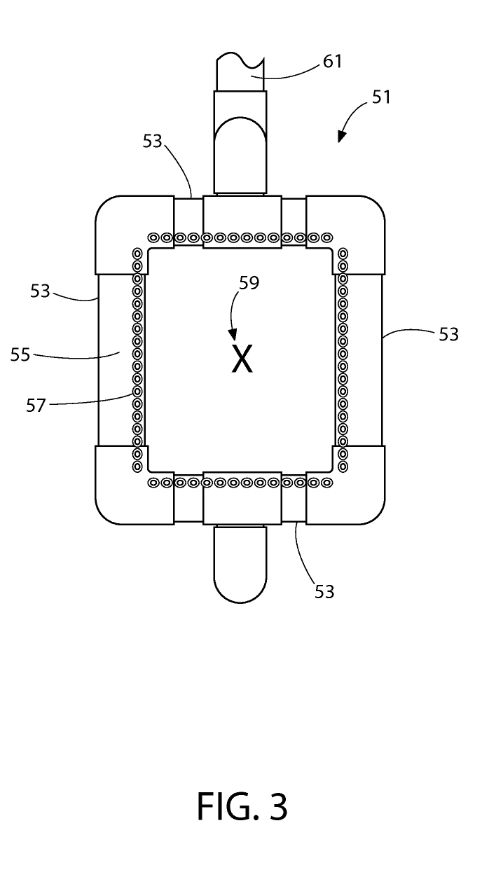

A steam supply manifold 51 which may be used with certain embodiments is illustrated in FIG. 3. This manifold 51 is formed of four manifold segments 53, each of which includes a steam exhaust 55 in the form of a plurality of steam ports 57 formed in a sidewall of the manifold 51. The four manifold segments 53 are linked at their ends to form an annular conduit that, when affixed to a applicator head, the applicator head passes through the central opening of the manifold, and the manifold substantially circumscribes a periphery of the applicator head. Each steam exhaust 55 is configured to direct steam toward the reference zone 59, which is approximately at the center of the manifold in this embodiment. Each of the four steam exhausts 55 is also positioned on an opposite side of the reference zone 59 from one of the other steam exhausts 55, so that each steam exhaust has a different angular position with respect to the axis and/or the reference zone. While this manifold 51 is depicted with four sides, taking on a square shape so that the steam exhausts are spaced apart angularly by about 90°, in certain embodiments a manifold can have more or fewer than four sides, or certain embodiments may take on other forms of geometric shapes, or certain embodiments may have an irregular shape. For example, in certain embodiments the steam exhausts may be spaced apart angularly by about 45°, relative to either an axis of the applicator head or a reference zone, or they may be spaced apart angularly by anywhere from about 45° to 180°. In certain embodiments, this angular spacing may be determined based upon the position of a single, central steam port within the steam manifold. Alternatively, in embodiments where the steam ports are slits or have a more irregular shape or distribution, the angular spacing may be determined based upon edge-to-edge distances between opposite sides of the steam exhaust.

Steam is delivered to the manifold 51 by a steam supply conduit 61. In certain embodiments, more than one steam supply conduit may feed the manifold so that the manifold delivers the desired amount through each steam exhaust. Alternatively, in certain embodiments, where the steam exhausts are segmented and not linked at their respective ends, each steam supply conduit may provide steam to only steam exhaust.

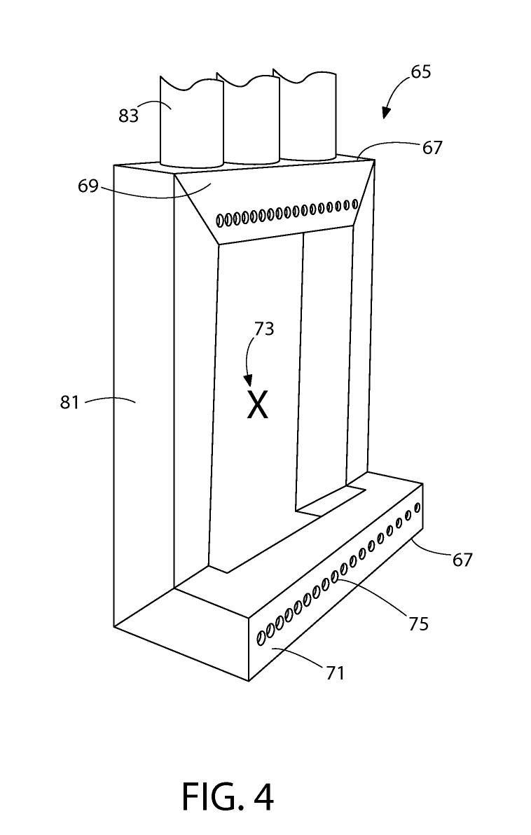

Another embodiment of a steam supply manifold 65 is illustrated in FIG. 4. This manifold 65 includes two steam exhausts 67 formed in an upper steam conduit 69 and a lower steam conduit 71, so that each steam exhaust 67 is on opposite peripheral sides of the reference zone 73. Such an arrangement would also place the steam conduits on opposite peripheral sides of an applicator head when the manifold 65 is positioned on an applicator head, so that the steam ports are 75 distributed along opposing peripheral sides of an applicator head. Each steam exhaust 67 in this embodiment includes a plurality of steam ports 75, and the upper and lower steam conduits 69, 71 are coupled by each of two side conduits 81. Steam is fed into the manifold 65 by three steam supply conduits 83 coupled to the upper steam conduit 69. In certain embodiments, more steam exhausts may be included in the steam supply manifold, and steam may be supplied to the manifold by more or fewer steam supply conduits.

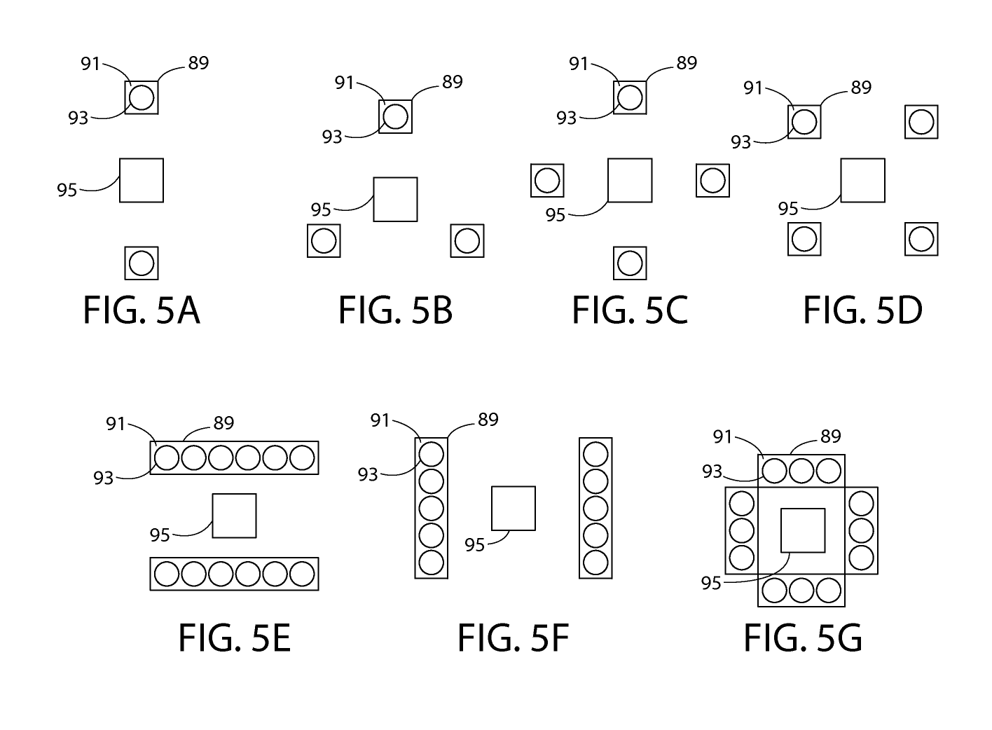

FIGS. 5A-5G illustrate various schematic layouts of certain embodiments of steam conduits 89 having steam exhausts 91, and the steam ports 93 of the steam exhausts 91, relative to a reference zone 95 for a humidifying apparatus. Certain embodiments of a humidifying apparatus may have schematic layouts that vary significantly from the few samples depicted here, with variations occurring in the number of steam conduits, the connectedness of the various steam conduits, the number of steam exhausts, the number of steam ports per steam exhaust, and the relative angular position of each steam exhaust with respect to a reference zone and with respect to other steam exhausts.

FIG. 5A shows a configuration that is similar to that of FIG. 1, with two steam conduits 89, each having a steam exhaust 91, and each steam exhaust 91 having a single steam port 93, positioned on opposite peripheral sides of the reference zone 95. FIG. 5B shows a configuration in which three steam conduits 89, each having a steam exhaust 91, and each steam exhaust 91 having a single steam port 93, are located at angular positions that differ by about 60° from the location of adjacent steam exhausts 91, placing the steam exhausts on three different peripheral sides of the reference zone. FIG. 5C shows a configuration in which four steam conduits 89, each having a steam exhaust 91, and each steam exhaust 91 having a single steam port 93, are located at angular positions that differ by about 90° from the location of adjacent steam exhausts 91. FIG. 5D also shows a configuration in which four steam conduits 89 each having a steam exhaust 91, and each steam exhaust 91 having a single steam port 93, are located at angular positions that differ by about 90° from the location of adjacent steam exhausts 91, except in FIG. 5D, as compared to FIG. 5C, the relative angular orientation of the steam exhausts with respect to the reference zone is different. FIG. 5E shows a configuration that is similar to that of FIG. 4, with two steam conduits 89, each having a steam exhaust 91, and each steam exhaust 91 having a plurality of steam ports 93, located on opposite peripheral sides of the reference zone 95. FIG. 5F also shows a configuration in which two steam conduits 89, each having a steam exhaust 91, and each steam exhaust 91 having a plurality of steam ports 93, are located on opposite peripheral sides of the reference zone 95, except in FIG. 5F, as compared to FIG. 5E, the relative angular orientation of the steam exhausts with respect to the reference zone is different FIG. 5G shows a configuration in which four steam conduits 89, each having a steam exhaust 91, and each steam exhaust 91 having a plurality of steam ports 93, are located at angular positions that differ by about 90° from the location of adjacent steam exhausts 91.

Existing coating systems may be retrofit with a humidifying, apparatus. In doing so, at least two steam exhausts are positioned to direct steam toward at least two peripheral sides of an applicator head of the coating system. The steam exhausts are coupled to a steam source through one or more steam supply conduits, and the steam source is activated, to dispense steam through the steam exhausts upon activation of the applicator head.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A system for applying a coating to a workpiece, the system comprising:
an applicator head configured to direct a water-based liquid onto the workpiece and remove excess liquid through a vacuum; and
a humidifying apparatus operably coupled to a steam source, the humidifying apparatus comprising first and second steam exhausts configured to direct steam toward the applicator bead,
wherein the first steam exhaust is located at a first angular position relative to an axis of the applicator head, and the second steam exhaust is located at a second angular position relative to the axis of the applicator head, the first angular position being different than the second angular position.

2. The system according to claim 1 wherein the humidifying apparatus is configured to exhaust steam through the first and second steam exhausts upon activation of the applicator head.

3. The system according to claim 1 wherein the first and second angular positions are at least 45 degrees apart.

4. The system according to claim 1 wherein the first and second steam exhausts are located on opposite peripheral sides of the applicator head.

5. The system according to claim 1 wherein the first steam exhaust comprises a first plurality of steam ports and the second steam exhaust comprises a second plurality of steam ports.

6. The system according to claim 1 wherein the humidifying apparatus further comprises third and fourth steam exhausts, the third steam exhaust located at a third angular position relative to the axis of the applicator head and the fourth steam exhaust located at a fourth angular position relative to the axis of the applicator head, and wherein each of the first, second, third and fourth angular positions are different from one another.

7. The system according to claim 6 wherein the first steam exhaust comprises a first plurality of steam ports, the second steam exhaust comprises a second plurality of steam ports, the third steam exhaust comprises a third plurality of steam ports, and the fourth steam exhaust comprises a fourth plurality of steam ports.

8. (canceled)

9. The system according. to claim 1 wherein the humidifying apparatus further comprises a steam supply manifold comprising an annular conduit comprising the first and second steam exhausts, and wherein the steam supply manifold is affixed to the applicator head so that the axis of the applicator head passes through a central opening of the annular conduit.

10. The system according to claim 1 wherein the humidifying apparatus further comprises one or more steam supply conduits operably coupling the steam exhausts to the steam source.

11. The system according to claim 1 wherein the axis of the applicator head is substantially perpendicular to a travel direction of the workpiece past the applicator head and substantially parallel to an application direction of the applicator head.

12. A system for applying a coating to a workpiece, the system comprising:
an applicator head configured to direct a liquid onto the workpiece and remove excess liquid through a vacuum; and
a humidifying apparatus operably coupled to a steam source, the humidifying apparatus comprising a steam supply manifold mounted to the applicator head, the steam supply manifold comprising a plurality of steam ports configured to direct steam toward at least two peripheral sides the applicator head.

13. The system according to claim 12 wherein the steam supply manifold further comprises a plurality of conduits, each of the conduits comprising at least one of the plurality of steam ports formed into a sidewall thereof.

14. The system according to claim 13 wherein the plurality of conduits are arranged to substantially circumscribe a periphery of the applicator head.

15. (canceled)

16. (canceled)

17. The system according to claim 12 wherein the plurality of steam ports are arranged to direct steam toward at least three peripheral sides of the applicator head.

18. The system according to claim 12 wherein the humidifying apparatus is Configured to produce steam upon activation of the applicator head.

19. The system according to claim 12 wherein the plurality of steam ports are distributed along two opposing peripheral sides of the applicator head.

20. A system for humidifying an applicator head configured for coating a workpiece, the system comprising:
at least one steam supply conduit operably coupled to a steam source; and
first and second steam exhausts operably coupled to the at least one steam supply conduit and configured to direct steam toward at least two different peripheral sides of a reference zone.

21. The system according to claim 20 wherein the first steam exhaust comprises a first plurality of steam ports and the second steam exhaust comprises a second plurality of steam ports.

22. (canceled)

23. The system according to claim 20 wherein the first and second steal exhausts are located on opposite sides of the reference zone.

24. The system according to claim 20 further comprising a steam supply manifold comprising an annular conduit comprising the first and second exhausts, wherein a central opening of the annular conduit comprises the reference zone.

25.-27. (canceled)
